(19) United States
(12) Patent Application Publication
(10) Pub. No.: US 2016/0130402 A1
(43) Pub. Date: May 12, 2016

(54) CURABLE COMPOSITIONS CONTAINING SILYL GROUPS AND HAVING IMPROVED STORAGE STABILITY

(71) Applicant: EVONIK DEGUSSA GMBH, Essen (DE)

(72) Inventors: Frank Schubert, Neukirchen-Vluyn (DE); Wilfried Knott, Essen (DE)

(21) Appl. No.: 14/896,781

(22) PCT Filed: Jun. 16, 2014
(86) PCT No.: PCT/EP2014/062498

§ 371 Date: Dec. 8, 2015

(30) Foreign Application Priority Data
Jul. 12, 2013 (DE) 10 2013 213 655.2

(51) Int. Cl. C08G 77/26; C08K 3/26

(52) U.S. Cl. CPC C08G 77/26; C08K 3/26; C08K 2003/265

(57) ABSTRACT

The invention relates to moisture-curing compositions with increased storage stability based on compounds bearing silyl groups and use thereof.

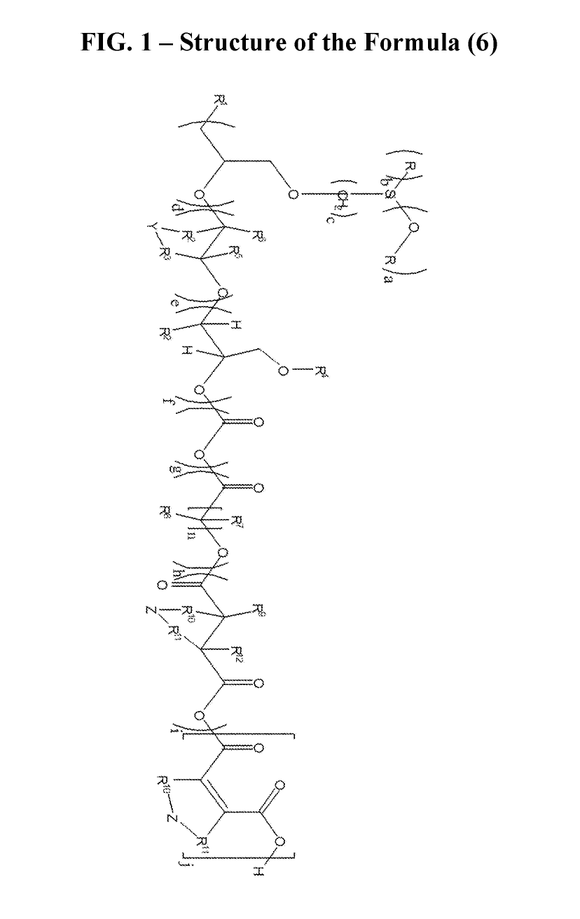

The invention relates to moisture-curing compositions with increased storage stability based on compounds bearing silyl groups and use thereof.

Prepolymer systems having reactive alkoxysilyl groups have long been known and are frequently used for preparing elastic sealants and adhesives in the industrial and building sectors. In the presence of air humidity and suitable catalysts, these alkoxysilyl-modified prepolymers are capable of condensing with one another, even at room temperature, with cleavage of the alkoxy groups and formation of an Si—O—Si bond. Therefore, these prepolymers, inter alia, can be used as single-component systems, which have the advantage of simple handling since two components do not have to be added and mixed.

The prior art includes numerous differently constructed polymer base structures to which the alkoxysilyl groups are chemically bonded.

For instance, terminal alkoxysilyl-functional polyurethanes are featured, for example, in the overview article in “Adhesives Age” April/1995, page 30 ff. (Authors: Ta-Min Feng, B. A. Waldmann). Particularly widely used are alkoxysilyl-terminated prepolymers which have an organic backbone and are based, for example, on polyurethanes, polyethers, polyesters, polyacrylates, polyvinylesters, ethylene-olefin copolymers, styrene-butadiene copolymers or polyolefins, described, inter alia, in EP 0 372 561, WO 00/37533 or U.S. Pat. No. 6,207,766. In addition however are widely used systems in which the backbone consists entirely or at least in part of organosiloxanes, described, inter alia, in WO 96/34030. Furthermore, alkoxysilyl-functional prepolymers having a poly(meth)acrylate backbone are also known.

The teaching of WO 2008/058955 provides further free silyl compounds as additional components to be added, which may assume several functions. These may function as water scavengers (improving storage stability), as crosslinkers and/or reactive diluents (increasing the network density and thus improving the mechanical properties) and not least as adhesion promoters. As detailed in WO 2008/058955, low molecular weight alkoxysilyl compounds, having a basic NH₂, NH³, or N(R³)₂ group, may take on the role not only of an adhesion promoter but even that of a curing catalyst or at least of a curing co-catalyst.

Polymers bearing alkoxysilyl groups are generally used as binder components in curable mixtures. In so-called 1K systems, these polymers are present in a mixture with mostly inorganic fillers, plasticizers, rheology aids, reactive diluents, curing catalysts, water scavengers, adhesion promoters, color pigments, UV stabilizers and, for example, antioxidants. With exclusion of water, for example, when protected from air humidity in cartridges, these curable mixtures must be stable over a period of several months. Only during the application, for example during the extrusion of the curable mass from the cartridge, does the intended curing reaction start in the presence of air humidity.

The major advantage of 1K systems in contrast to 2K systems is the simplicity of the application for the user. Moisture-curing 1K mixtures, however, make high demands on the choice of the mixing components and on the formulation process under strict moisture exclusion. Traces of moisture in the starting materials are critical, such that it is standard practice to add water scavengers such as vinyltrialkoxysilanes prophylactically to the curable mixtures. These silyl compounds particularly reactive towards water prevent inadvertent crosslinking of the polymers bearing alkoxysilyl groups and ensure improved storage stability.

Also critical are interactions and chemical reactions of the components of a curable mixture with one another. This applies in particular to the interaction of prepolymers bearing alkoxysilyl groups and basic amino-functional alkoxysilane adhesion promoters and more particularly when curing catalysts, such as the widely used tin catalysts, are added at the same time.

As explained, for example, in US 2010/0029860 A1, aliphatic and cycloaliphatic amines are curing catalysts for alkoxysilyl compounds. For many applications, aminosilane adhesion promoters are indispensable ingredients to ensure substrate binding to the cured adhesives and sealants. According to the prior art, the negative effect of these compounds on the storage stability of single-component, moisture-curable and alkoxysilyl group-containing mixtures is usually taken into account.

The tendency towards an undesired incipient crosslinking during storage is increased by those components of a curable mixture having functional groups which are capable of reactions or interactions with the alkoxysilyl groups. These include, in addition to carboxylic acids and other azidic compounds, hydroxyl compounds such as alcohols, phenols, silanols having SiOH functions and especially polyetherols.

Polyethers bearing alkoxysilyl groups according to EP 2093244, which themselves have terminal OH groups, show a particularly high tendency to crosslink even under very dry conditions. As explained in EP 2415796, the storage stability in the presence of metal catalysts and amines is insufficient, so that attempts are made in the method disclosed therein, to reduce the reactivity of the OH function by introducing bulky end groups.

EP 2415797 describes a method in which the terminal OH group of the polymer is capped by reaction with e.g. isocyanates, hexamethyldisilazane or anhydrides, in order to improve the storage stability of curable mixtures.

In the case of insufficient storage stability, hydrolysis and/or transesterification of the alkoxysilyl functions also occur in sealed containers and possibly condensation reactions of the Si-containing groups with each other. Due to the increasing molar mass, the curable mixture is over a period of time always more viscous and finally solid, such that the intended use is no longer possible. There is still a need for new ways to improve the storage stability of curable mixtures.

Aminosilanes bearing imine groups are known from the prior art; also various possibilities for the preparation and use thereof. For instance, the German patent specification DBP 1104508 describes, besides the preparation of imines, the use as UV absorber in sun creams, as chelating agents and as vulcanization/curing agent in silicone elastomers. WO 2007/034987 mentions the use of highly pure imine-modified silanes as adhesion promoters and curing agent in single-component curable resin systems such as epoxy, urethane and phenolic resin systems. EP 1544204 discloses particularly low odor silanes bearing imine groups, which are prepared from selected aldehydes without a hydrogen atom on the carbon. Due to their capped primary amine group, these compounds can be used in isocyanate-containing curable 1K PU systems. Likewise, DE 3414877 describes PU applications. The use of imine-functional silanes, prepared from aromatic carbonyl compounds, for the surface treatment of glass fibers is shown in EP 0768313. To the present day, therefore, no moisture-curing compositions comprising compounds bearing silyl groups are known in which composition imines can be used without compromising the storage stability of the composition or secondly negatively affecting their curing properties, for example, by slow curing or complete absence of curing. As already mentioned, there is, however, still a need for new ways to improve the storage stability of curable mixtures.

The object of the present invention is therefore to remedy the prevailing lack of storage stability of moisture-curing compositions according to the prior art, particularly comprising compounds bearing silyl groups.

The object of the present invention is also the provision of novel curable compositions comprising alkoxysilyl groups having improved storage stability and a method for preparation thereof which allows, in a simple manner, the OH endcapping of alkoxysilyl prepolymers comprising hydroxyl groups, i.e. to dispense with an additional reaction for lowering the reactivity of free OH groups (i.e. for protecting groups). Thus an additional reaction step can be omitted in the preparation of the prepolymers and thus time, spatial and financial resources can be saved.

It has been found, surprisingly, that imines of the formula (1) are stable adhesion promoters in moisture-curing compositions comprising prepolymers bearing alkoxysilyl groups, and which significantly increase the storage stability of curable mixtures compared to conventional aminosilane adhesion promoters, particularly compared to the aminosilane adhesion promoters of the formula (3), and at the same time enable the controlled curing of the composition as desired.

The invention therefore relates to moisture-curing compositions with increased storage stability which comprises silane adhesion promoters having imine groups in addition to prepolymers bearing silyl groups.

This object was able to be achieved by curable compositions comprising
a. at least one silane compound having imine groups and
b. at least one prepolymer comprising at least one silyl group.

The silane compound having imine groups is used here as adhesion promoter. Such compositions have excellent storage stability and have no instabilities even after several weeks. The compositions are also less sensitive to water compared to those compositions which comprise conventional silane adhesion promoters known from the prior art. In particular, small quantities of water do not lead to premature curing of the components, contrary to the properties of known curable compositions. Particularly surprisingly, it was found that the curable compositions according to the invention, in addition to the aforementioned positive properties, display a particularly good smell. Firstly, this is the case during use, i.e. the curing, where pleasant, noticeable smell is displayed, but secondly the emission of those smells commonly perceived as off-odor (bad or less pleasant smell) is significantly reduced.

Preference is given to those curable compositions according to the invention comprising less than 1% by weight, preferably less than 0.1% by weight, and more preferably less than 0.01% by weight of water and particularly preferably are free of water. Such compositions have particularly high stability with nevertheless good curing properties.

Preference is given to those curable compositions according to the invention further comprising no water scavengers, in particular no vinyltrimethoxysilane and vinyltriethoxysilane.

Preference is also given to those curable compositions further comprising calcium carbonate as component c), preferably in amounts of 1 to 60% by weight, preferably 10 to 50% by weight, particularly preferably 20 to 40% by weight, based on the total weight of the composition. Calcium carbonate serves in this case as filler. Although calcium carbonate also has known water-absorbing properties, in the context of this invention it is not among the group of the so-called water scavengers. In the context of this invention, calcium carbonate is understood to mean exclusively a filler. Curable compositions further comprising calcium carbonate as component c) have the advantage that the mechanical properties of the composition may be adjusted exquisitely to the desired properties in each case via the particle size of the calcium carbonate. For example, the strength of the composition can be perfectly controlled in this way.

In a particularly preferred embodiment of the present invention, the silane compound having imine groups of component a) is a reaction product of a silane compound having amine groups and a carbonyl compound preferably having a boiling point above 60° C., particularly preferably above 80° C. and particularly preferably above 100° C. Silane compounds having imine groups with carbonyl compounds having a boiling point over 100° C. can be particularly easily handled in the preparation. The use of such components also has the surprising advantage that the curable compositions with such silane compounds having imine groups have particularly good fragrance properties. Firstly, the liberated carbonyl compound produces a long-lasting, pleasant, perceptible smell. Furthermore, the emission of such smells commonly perceived as off-odor (bad or less pleasant smell) is particularly significantly reduced when carbonyl compounds having boiling points above 100° C. are used. The moisture-curing compositions according to the invention, of which the silane compound having imine groups of component a) was prepared based on carbonyl compounds having a boiling point above 100° C., therefore have a particularly long-lasting release effect linked to a pleasant odor and at the same time reduce the emission of typical odors of comparable moisture-curing compositions.

The invention further relates to the use of silane compounds having imine groups as adhesion promoters in curable compositions.

The invention in addition further relates to the use of curable compositions according to the invention comprising at least one silane compound having imine groups and at least one prepolymer comprising at least one silyl group, and also the preferred embodiments of these curable compositions, as adhesives and sealants, for surface coating and surface modification, as reactive crosslinkers, primers and binders for various substrates such as metals, glass and glass fibers/glass fabrics, wood, plastics and silicatic materials.

The adhesion promoters used in the scope of the present invention, namely the silane compounds having imine groups of component a), have at least one imine group and at least one silicon-containing residue per molecule. The imines referred to in the context of this invention are compounds comprising the structural unit of the formula (1a)

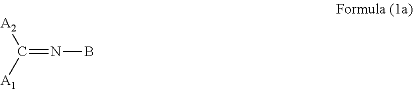

where

A₁ and A₂ are mutually independently hydrogen or an organic residue, wherein the residues A₁ and A₂ are preferably derived from the condensation reaction (i.e. a reaction with elimination of one equivalent of water) of an amine-functional compound, for example according to formula (3), with a carbonyl compound, for example according to formula (4), and thus by way of preference the residues correspond to the carbonyl compound used, wherein in the case that the residues derive from a compound having a keto function, both residues A₁ and A₂ are each an organic residue and in the case that the residues derive from a compound having an aldehyde function, at least one of the two residues A₁ and A₂ is an organic residue and the other residue is hydrogen respectively, and

B is an organic residue having at least one silicon-containing residue.

Depending on the type of the residues A1 and A2, such compounds are often also referred to as ketimines or Schiff s bases. The adhesion promoters used in the context of the present invention have at least one such imine group in the molecule. The imine group is attached to a silicon-containing residue via the organic residue B.

In a preferred embodiment, the silane compounds having imine groups of component a) used in accordance with the invention are modified aminosilanes according to formula (1)

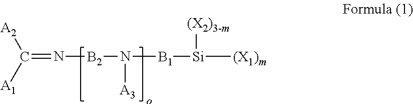

where
X₁ is mutually independently an alkoxy or an aryloxy residue, preferably having 1 to 8 carbon atoms, particularly preferably is a methoxy, ethoxy, isopropoxy, n-propoxy, butoxy or phenoxy residue,
X₂ is an alkyl, alkenyl, aryl, alkylaryl or aralkyl residue, preferably an alkyl residue having 1 to 20 carbon atoms, particularly preferably is an alkyl residue having 1 to 8 carbon atoms, particularly preferably is a methyl, ethyl, n-propyl, isopropyl, butyl, isobutyl or tert-butyl group,
m is 0, 1, 2 or 3, preferably 2 or 3,
o is 0 or 1, preferably 0,
A₁ and A₂ are mutually independently hydrogen or an organic residue, with the proviso that both residues A₁ and A₂ cannot simultaneously be hydrogen, preferably are hydrogen, an alkyl, cycloalkyl, alkenyl, aryl, alkylaryl or aralkyl residue, which may in turn be substituted, particularly preferably are hydrogen or a phenyl, cyclohexyl or an alkyl residue having 1 to 20 carbon atoms,

B₁ and B₂ are mutually independently divalent hydrocarbon residues having 1 to 18 carbon atoms, preferably having 1 to 6 carbon atoms, particularly preferably are a —CH₂—, —CH₂—CH₂— or —CH₂—CH₂—CH₂— residue,

A₃ is hydrogen or a substituted or unsubstituted residue selected from alkyl, cycloalkyl, alkenyl, aryl, alkylaryl or aralkyl residue, preferably is hydrogen. Such compounds of component a) in combination with the compounds of component b) result in particularly stable curable compositions, particularly in the case that o is 0.

The compounds of the formula (1) used in accordance with the invention may be prepared according to the method disclosed in DBP 1104508 from the aminosilanes of the formula (3) and carbonyl compounds of the formula (4) with elimination and, for example, removal of water by distillation. They may contain residues of these reactants if one of the starting materials was used in a molar excess for example or the condensation reaction does not go to completion. The imines (1) used in accordance with the invention may also comprise dimers, inter alia, oligomers which are linked to one another via Si—O—Si groups.

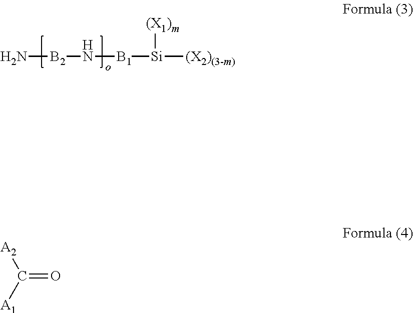

where A₁, A₂, B₁, B₂, X₁ and X₂ are defined as in formula (1).

By way of preference, the aminosilanes of the formula (3) used may be 3-aminopropyltrimethoxysilane (Dynasylan® AMMO (Evonik)), N-(2-aminoethyl)-3-aminopropyltrimethoxysilane (Dynasylan® DAMO (Evonik)), 3-aminopropyltriethoxysilane (Dynasylan® AMEO (Evonik®)), (3-aminopropyl)methyldiethoxysilane (Dynasylan® 1505 (Evonik®)) and/or 3-aminopropyltripropoxysilane, (3-aminopropyl)methyldimethoxysilane.

The aldehydes or ketones of the formula (4) used are preferably acetaldehyde, propionaldehyde, butyraldehyde, benzaldehyde, cinnamaldehyde, salicylaldehyde, tolualdehyde, anisaldehyde, acrolein, crotonaldehyde, acetone, methyl ethyl ketone, ethyl butyl ketone, ethyl n-propyl ketone, methyl isobutyl ketone, methyl amyl ketone, diethyl ketone, methyl isopropyl ketone, methyl n-propyl ketone, diisopropyl ketone, diisobutyl ketone, methyl pentyl ketone, cyclohexanone, cyclopentanone, acetophenone, benzophenone and/or isophorone. Particular preference is given to using such aldehydes or ketones of the above list having a boiling point above 80° C., preferably above 100° C., since these have quite outstanding storage stabilities in compositions according to the invention. Particular preference is given to 2-heptanone, benzaldehyde, cyclohexanone, anisaldehyde and/or cinnamaldehyde.

The compositions according to the invention comprise, in addition to at least one compound of the formula (1) having imine groups, at least one prepolymer having alkoxysilyl groups. The imines can be formulated with any silyl-functional compounds according to the invention having at least one alkoxysilyl group chemically bonded to a polymer structure. In a preferred embodiment, the prepolymer of component b) takes the form of at least one polyether bearing at least one silyl group and preferably at least one OH group. This polyether of component b) particularly preferably bears at least one OH group on at least one chain end.

Preferred silyl-functional compounds of component b) according to the invention are prepolymers having alkoxysilyl groups of the formula (5)

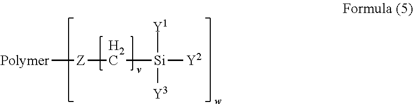

where
Y¹ Y² and Y³ are mutually independently alkyl or alkoxy residues having 1-8 carbon atoms,
Z is a residue comprising a divalent carboxy, carbamate, amide, carbonate, ureido or sulphonate group or is an oxygen atom,
w is an integer from 1 to 8, wherein the respective units with the index w are each mutually independently covalently bonded w-fold to the polymer and
v is an integer from 1 to 20, preferably 1 to 15, particularly preferably 1 to 5 and especially preferably 1, 2 or 3.

The polymer residue is selected from a group consisting of alkyd resins, oil-modified alkyd resins, saturated or unsaturated polyesters, natural oils, epoxides, polyamides, polycarbonates, polyethylenes, polypropylenes, polybutylenes, polystyrenes, polybutadienes, ethylene-propylene copolymers, (meth)acrylates, (meth)acrylamides and salts thereof, phenolic resins, polyoxymethylene homopolymers and copolymers, polyurethanes, polysulphones, polysulphide rubbers, nitrocelluloses, vinyl butyrates, vinyl polymers, ethylcelluloses, cellulose acetates and/or butyrates, rayon, shellac, waxes, ethylene copolymers, organic rubbers, polysiloxanes, polyethersiloxanes, silicone resins, polyethers, polyetheresters, polyether carbonates and mixtures thereof.

The polymers of the formula (5), used preferentially in mixtures with the silanes comprising imine groups (1), include so-called α-silane-terminated polymers whose reactive alkoxysilyl groups are separated only by one methylene unit (v=1) from a polymer-bound group Z, preferably a nitrogen-containing polymer-bound group Z. α-Silane polymers of this kind bound to a polymer structure, preferably via a urethane or urea unit, usually comprise methoxy or ethoxy groups as substituents of the silicon. The polymer structure in this case may be either linear or branched and either organic or siliconic in nature. Particular preference is given to α-silanes attached terminally to the ends of polyethers. Of particular significance are polyalkylene oxides, especially polypropylene glycols (w=2), with α-silane functions at each of the chain ends, as sold under the names Geniosil© STP-E10 and Geniosil© STP-E30 by Wacker. The preparation of such α-silane prepolymers is described, for example, in PCT EP 05/003706 and EP-A1-1967550. Particularly suitable for use in mixtures with the imine compounds (1) are, for example, methyl dimethoxy(methyl)silylcarbamate- and/or methyl trimethoxysilylcarbamate-terminated polyethers.

Further particularly preferred silane polymers of the formula (5) and which can be used in curable compositions with the imines (1) are those in which the silane groups are terminally bonded to a polymer structure via a propylene unit (v=3), wherein it is further preferred if at the same time Z is a urethane group. Preference is given to polyalkylene oxides, especially polypropylene glycols (w=2), with silane functions at each of the chain ends, as are obtainable under the names Geniosil© STP-E15 and Geniosil© STP-E35 from Wacker, for example. The preparation of such silane polymers is described, for example, in EP 1824904. Particularly suitable for use in mixtures with the imine compounds (1) are, for example, propyl dimethoxy(methyl)silylcarbamate- and/or propyl trimethoxysilylcarbamate-terminated polyethers.

Compounds of the formula (5) also suitable as mixture constituents are silane-terminated polyurethanes, the preparation of which from a polyol by reaction with a diisocyanate and subsequently with an amino-functional alkoxysilane is described, for example in U.S. Pat. No. 7,365,145, U.S. Pat. No. 3,627,722 or U.S. Pat. No. 3,632,557. The binding group Z in this case is a residue bearing urethane and urea groups. A typical representative of this class of silane polymers is, for example, Desmoseal©XP 2636 from Bayer Material Science.

Preference is given to curable compositions according to the invention which, in addition to at least one imine of the formula (1), comprise such prepolymers bearing silyl groups which have terminal OH functions. Such silylated polymers are described, for example, in EP 2 093 244, which is hereby fully incorporated as part and subject matter of this disclosure, and may be prepared by alkoxylation of epoxy-functional silanes over double metal cyanide catalysts. These products are referred to hereinafter as silyl polyethers.

The silyl polyether, which may have both alkoxysilane functions within the sequence of the oxyalkylene units of the polyether chain and novel alkoxysilane functions at the termini thereof, allow the anchor group density in the desired prepolymer to be adjusted at will, i.e. adapted to the particular application objective.

A preferred silyl group in the context of this invention is characterized by the same or different organic or oxyorganic residues. In a particularly preferred embodiment, the compound of component b) takes the form of at least one silyl polyether of the formula (6)

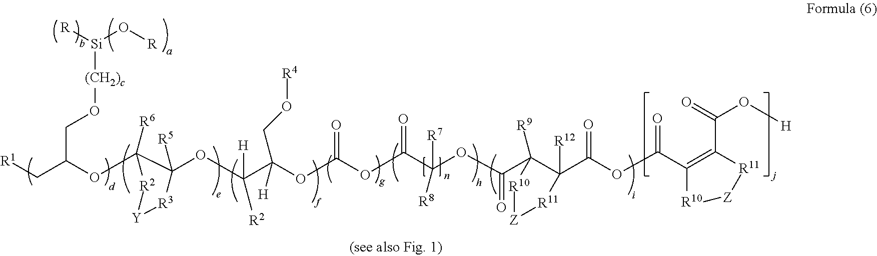

where
a is an integer from 1 to 3, preferably 3,
b is an integer from 0 to 2, preferably 0 to 1, particularly preferably 0, and the sum of a and b is equal to 3,
c is an integer from 0 to 22, preferably from 1 to 12, particularly preferably from 2 to 8, especially preferably from 0 to 4 and in particular is equal to 1 or 3,
d is an integer from 1 to 1000, preferably greater than 1 to 100, particularly preferably 4 to 20 and especially preferably 5 to 12 and in particular is greater than 4 to 10,
e is an integer from 0 to 10 000, preferably 1 to 2000, particularly preferably 5 to 1000 and in particular is 10 to 500,
f is an integer from 0 to 1000, preferably greater than 0 to 100, particularly preferably 1 to 50 and in particular is 0 to 30,
g is an integer from 0 to 1000, preferably greater than 0 to 200, particularly preferably 1 to 100 and in particular is 0 to 70,
h, i and j are integers from 0 to 500, preferably greater than 0 to 300, particularly preferably 1 to 200 and in particular is 0 to 100,
n is an integer between 2 and 8
and with the proviso that the fragments with the indices d to j are freely permutable with one another, i.e. are exchangeable relative to one another in the sequence within the polyether chain and
R corresponds to one or more identical or different residues selected from linear or branched, saturated, mono- or polyunsaturated hydrocarbon residues or haloalkyl residues each preferably having 1 to 20, particularly 1 to 6 carbon atoms, preferably R is a methyl, ethyl, propyl, isopropyl, n-butyl or secondary butyl group; and
R¹ corresponds to a saturated or unsaturated, optionally branched residue, which is preferably attached via an oxygen atom, or is a polyether residue of the type of an alkoxy, arylalkoxy or alkylarylalkoxy group, in which the carbon chain can be interrupted by oxygen atoms, or le is an optionally singly or multiply fused aromatic aryloxy group, wherein the residue le in the silyl polyether preferably has no silicon atom, and also
Y may not be present, or may be a methylene bridge with 1 or 2 methylene units and, if Y is present, the residues R² and R³ are each divalent; if Y is not present, the residues R² and R³ are each monovalent.
R² and R³ mutually independently correspond to hydrogen or a saturated or optionally mono- or polyunsaturated, also further substituted, with halogen or hydroxyl groups for example, linear or branched monovalent (if Y not present) or divalent (if Y present) hydrocarbon residue, preferably having 1 to 20, more preferably having 1 to 10 carbon atoms and particularly preferably having 1 to 6 carbon atoms; preferance is given to a linear, unsubstituted hydrocarbon residue having 1 to 6 carbon atoms; the hydrocarbon residue may be bridged cycloaliphatically via the fragment Y; if Y is present, neither of the residues R² or R³ can be hydrogen, rather both residues R² or R³ are then divalent hydrocarbons; R²—Y—R³ may be a —CH₂CH₂CH₂CH₂— group, Y therefore a-(CH₂CH₂—) group and R² and R³ each a divalent hydrocarbon residue having one carbon atom. Both residues R² and R³ very particularly preferably correspond to hydrogen or one of the residues R² or R³ corresponds to hydrogen and the other residue corresponds in each case to a methyl, ethyl, propyl, butyl or phenyl residue. With preference, at least one of the two residues R² or R³ is hydrogen.

R⁴ corresponds to a linear or branched alkyl residue of 1 to 24 carbon atoms or an aromatic or cycloaliphatic residue which may in turn bear alkyl groups;

R⁵ and R⁶ mutually independently correspond to hydrogen or a saturated or optionally mono- or polyunsaturated, also further substituted, with halogen or hydroxyl groups for example, linear or branched monovalent hydrocarbon residue, preferably having 1 to 20, more preferably having 1 to 10 carbon atoms and particularly preferably having 1 to 6 carbon atoms; preference is given to a linear, unsubstituted hydrocarbon residue having 1 to 6 carbon atoms; the residues R⁵ and R⁶ are preferably mutually independently hydrogen, methyl, ethyl, propyl, butyl or phenyl residues, and especially preferably both residues R⁵ and R⁶ are hydrogen,
R⁷ and R⁸ are mutually independently either
hydrogen, alkyl, alkoxy, aryl or aralkyl groups,
R⁹, R¹⁰, R¹¹and R¹² are mutually independently either hydrogen, alkyl, alkenyl, alkoxy, aryl or aralkyl groups. The hydrocarbon residue can be bridged cycloaliphatically or aromatically via the fragment Z, where Z may be either a divalent alkylene or alkenylene residue.

As shown by ²⁹Si-NMR and GPC investigations, the method-related presence of chain-end OH groups means that transesterification reactions on the silicon atom are possible not only during the DMC-catalyzed preparation but also, for example, in a subsequent process step. In that case, formally, the alkyl residue R bonded to the silicon via an oxygen atom is replaced by a long-chain, modified alkoxysilyl polymer residue. Bimodal and multimodal GPC plots demonstrate that the alkoxylation products include not only the untransesterified species, as shown in formula (6), but also those with twice, in some cases three times, or even four times the molar mass. Formula (6) therefore provides only a simplified representation of the complex chemical reality.

The silyl polyethers therefore constitute compositions which comprise compounds in which the sum of the indices (a) plus (b) in formula (6) is on average less than 3, since some of the OR groups may be replaced by silyl polyether groups. The compositions therefore comprise species which are formed on the silicon atom with elimination of R-OH and condensation reaction with the reactive OH group of a further molecule of the formula (6). This reaction may proceed multiply until, for example, all of the RO groups on the silicon have been replaced by further molecules of the formula (6). The presence of more than one signal in typical ²⁹Si-NMR spectra for these compounds underlines the occurrence of silyl groups with different substitution patterns.

The specified values and preferred ranges for the indices (a) to (j) should therefore only be understood as average values across the various, individually intangible species. The diversity of chemical structures and molar masses is also reflected in the broad molar mass distributions of M_{w}/Mₙ of mostly ≧1.5, which are typical for silyl polyethers and entirely unusual for conventional DMC-based polyethers.

Starters or starter compounds used for the alkoxylation reaction may be any compounds of the formula (7)

R¹—H Formula (7)

(the H includes the OH group of a compound having at least one hydroxyl group, for example, an alcohol or a phenolic compound), alone or in mixtures with one another, which have at least one reactive hydroxyl group according to formula (7). R¹ corresponds to a saturated or unsaturated, optionally branched residue, which has at least one oxygen atom of a hydroxyl group, or is a polyether residue of the type of an alkoxy, arylalkoxy or alkylarylalkoxy group, in which the carbon chain can be interrupted by oxygen atoms, or R¹ is an optionally singly or multiply fused aromatic aryloxy group. The chain length of the polyether residues having alkoxy, arylalkoxy or alkylarylalkoxy groups which can be used as starter compounds is arbitrary. The polyether, alkoxy, arylalkoxy or alkylarylalkoxy group preferably comprises 1 to 1500 carbon atoms, particularly preferably 2 to 300 carbon atoms, in particular 2 to 100 carbon atoms.

Starter compounds are understood to mean substances that form the start of the polyether molecule (6) to be prepared, which is obtained by the addition of epoxide-functional monomers. The starter compound used in the method is preferably selected from the group of alcohols, polyetherols or phenols. The starter compound used is preferably a mono- or polyfunctional polyether alcohol or alcohol R¹—H (the H includes the OH group of the alcohol or phenol).

The OH-functional starter compounds R¹—H (7) used are preferably compounds having molar masses of 18 to 10,000 g/mol, particularly 50 to 2000 g/mol and having 1 to 8, preferably having 1 to 4 hydroxyl groups and further preferably having at least 8 carbon atoms per molecule.

Examples of compounds of the formula (7) include allyl alcohol, butanol, octanol, dodecanol, stearyl alcohol, 2-ethylhexanol, cyclohexanol, benzyl alcohol, ethylene glycol, propylene glycol, di-, tri- and polyethylene glycol, 1,2-propylene glycol, di- and polypropylene glycol, butane-1,4-diol, hexane-1,6-diol, trimethylolpropane, glycerol, pentaerythritol, sorbitol, cellulose sugar, lignin or also other hydroxyl group-bearing compounds based on natural products. The corresponding alkoxy residue in each case is the residue R7, i.e. butyloxy is the residue R7 in the case of butanol for example.

Advantageously, starter compounds used are low molecular weight polyetherols having 1 to 8 hydroxyl groups and molar masses of 50 to 2000 g/mol, which have been prepared in turn beforehand by DMC-catalyzed alkoxylation.

As well as compounds with aliphatic and cycloaliphatic OH groups, any desired compounds having 1 to 20 phenolic OH functions are suitable. These include, for example, phenol, alkyl- and arylphenols, bisphenol A and novolacs.

The various monomer units both in the fragments with the index numbers d to j and in the polyoxyalkylene chains of the substituents le ₚossibly present may have a block structure in relation to one another or else be subject to a statistical distribution. The fragments are freely permutable with one another in the sequence thereof, with the limitation that cyclic anhydrides and carbon dioxide are present in the polyether structure randomly inserted, i.e. not in homologous blocks.

The index numbers reproduced here and the value ranges for the indices indicated in the formulae shown here are therefore understood as average values of the possible statistical distribution of the structures and/or mixtures thereof that are actually present. This also applies to structural formulae exactly reproduced per se as such, for example, formula (6).

The alkoxysilane unit in the compound of the formula (6) is preferably a trialkoxysilane unit.

In the context of the present invention the term polyether encompasses not only polyethers, polyetherols, polyether alcohols and polyether esters but also polyethercarbonates, which may be used synonymously with one another. The term “poly” is not necessarily to be understood as meaning that there are a multiplicity of ether functionalities or alcohol functionalities in the molecule or polymer. It is rather merely used to indicate the presence of at least repeating units of individual monomeric building blocks or else compositions that have a relatively high molar mass and further exhibit a certain polydispersity. The word fragment “poly” means in the context of this invention not only exclusively compounds having at least 3 repeating units of one or more monomers in the molecule, but also especially such compositions of compounds having a molecular weight distribution, and thereby have an average molecular weight of at least 200 g/mol. This definition takes into account that it is customary in the field of industry in question to refer to such compounds as polymers even if they do not appear to conform to a polymer definition as per OECD or REACH guidelines.

The polymer architecture of these crosslinkable polyethers may be varied in many ways depending on the type of starter, and also by type, amount and sequence of the epoxide monomers that can be used. The silyl polyethers, virtually unlimited with respect to their structural diversity, open a great freedom of configuration to those skilled in the art, by means of incorporation, for example, of ester, carbonate and aromatic structural elements.

Other polymers bearing silyl groups which may be used in the context of the invention are the long-known urethane- and urea-free silyl-terminated polyethers of the formula (5) where A is oxygen, in which the terminal alkoxysilyl groups are attached directly to the polymer structure via an ether function. Silyl polymers of this kind are described in U.S. Pat. No. 3,971,751. They consist preferably of a polyether base structure, where v in formula (5) preferably has the value 3 and w preferably has the value 2, and are obtainable as MS Polymer© products from Kaneka. Such curable silyl polyethers are extremely suitable as elastic sealants and adhesives, but are only capable of forming a low network density due to alkoxysilyl groups attached only terminally to a long polymer structure of about 10 000 g/mol. Both polysiloxanes bearing alkoxysilyl groups, such as described in WO 2007/061847, and silyl polyethers urethanized by reaction with isocyanates, such as are disclosed in DE 10 2009 028636 and DE 10 2009 028640, may be combined with the imines of the formula (1).

The imine-functional adhesion promoters can likewise be used in mixtures with conventional monomeric silanes of the formula (8)

W_{y}SiV_{(4-y)} (8)

where W represents the same or different non-hydrolysable groups, V represents the same or different hydrolysable groups or hydroxyl groups and y=1, 2, 3 or 4. The imine compounds should be as pure as possible in this case and have no reactive primary or secondary amine groups which may react with the also reactive silanes of the formula (8).

The hydrolysable groups V in formula (8) may be, for example, halogen, alkoxy (preferably methoxy, ethoxy, i-propoxy, n-propoxy or butoxy), aryloxy (preferably phenoxy), acyloxy (preferably acetoxy or propionyloxy) or acyl (preferably acetyl) groups. The non-hydrolysable residue W may be, for example, an alkyl, alkenyl, alkynyl, aryl, alkylaryl or aralkyl residue. The alkyl chain may have 0 to 50, preferably 0 to 22 carbon atoms and also may be interrupted by heteroatoms such as oxygen or nitrogen or sulphur or even a silicon residue. The aromatic residue may also be heteroaromatic. The residues W and V may optionally have one or more customary substituents such as halogen or alkoxy.

Non-hydrolysable residues W according to the formula (8) having functional groups may be selected from the range of glycidyl or glycidyloxyalkylene residues such as β-glycidyloxyethyl, γ-glycidyloxypropyl, δ-glycidyloxypropyl, ε-glycidyloxypentyl, ω-glycidyloxyhexyl or 2-(3,4-epoxycyclohexyl)ethyl, the range of methacryloxyalkylene and acryloxyalkylene residues such as methacryloxymethyl, acryloxymethyl, methacryloxyethyl, acryloxyethyl, methacryloxypropyl, acryloxypropyl, methacryloxybutyl or acryloxybutyl, and the 3-i socyanatopropyl residue.

Such organofunctional monomeric silanes are, for example, vinyltrimethoxysilane, vinyltriethoxysilane, vinyldimethoxymethylsilane, 3-i socyanatopropyltrimethoxysilane, 3-glycidyloxypropyltrimethoxysilane, 3-glycidyloxypropyltriethoxysilane, 3-methacryloxypropyltrimethoxysilane, methyltrimethoxysilane, methyltriethoxysilane, dimethyldimethoxysilane, phenyltriethoxysilane and/or hexadecyltrimethoxysilane, alone or in mixtures with one another. An introduction to this topic is found in “Silylated Surfaces”, edited by Donald E. Leyden and Ward T. Collins, Gordon and Breach Science Publishers, Inc., 1980, ISBN 0-677-13370-7.

It is generally left to the expert to select suitable components for the desired profile of properties.

The curable mixtures according to the invention are suitable for example as base materials for the preparation of adhesives, for surface coating and surface modification, as reactive crosslinkers, as adhesion promoters and primers and also binders or sealants for various substrates such as metals, glass and glass fibers/glass fabrics, wood, wood-based materials, natural fibers, and also, for example, cork and general silicatic materials. For instance, the specific incorporation of anchored alkoxysilyl moieties via hydrolytic processes into brickwork, concrete, mortar etc, has proven to be extremely advantageous.

The compositions according to the invention may serve as binders, i.e. for bonding similar or different materials to one another, in the preparation of wood-based materials such as fiberboards or MDF boards, for bonding wood particles or cork particles and are also available for floors, wood blocks and laminate applications.

The compositions according to the invention may also have thermoplastic properties and therefore also serve to prepare moldings in which temperature-dependent flow behavior is required. The molding compositions may be used in processes such as injection molding, extrusion or hot pressing. The curable mixtures according to the invention may also be used without catalysts, such that a further crosslinking and curing during the molding process remains to be done. After crosslinking, the polymers bearing silyl groups are transferred into duroplastic products.

In this manner, polymeric materials optionally with foam-like structure may be obtained by applying known processes of free or catalytic curing of prepolymer systems. Due to the variability and variety of possible compositions according to the invention, the preferred form to be selected may be determined to suit the application.

The imine-functional silanes are preferably formulated as a latent adhesion promoter with silyl polyethers of the formula (6), wherein the silyl polyethers have on average more than one alkoxysilyl function per hydroxyl group.

The curable mixtures according to the invention comprising at least one component of the formula (1) may be used, for example, for coating and modifying flat, particulate, fibrous surfaces and fabrics and as sealants. The coating may be, for example, an adhesive coating, in particular a foamed adhesive coating. The curable mixture may also be used in the form of a dispersion or solution. If these compositions according to the invention should be foamable, these comprise one or more, optionally chemically formed blowing agents.

The surfaces to be coated may be coated by known means such as spraying, spreading, dipping, etc. The surfaces to be bonded are preferably pressed onto one another in the process. The application of the optionally foamable mixture for producing the adhesive bond is preferably carried out from a pressurized can, wherein the formation of foam takes place by means of the blowing agent, optionally liberated also by chemical reaction, present in the mixture.

Preference is given to curable compositions also comprising a curing catalyst as component d), preferably a tin catalyst. The curable compositions according to the invention have the advantage that they are stable even in the presence of curing catalyst and/or low amounts of water such that formulation as a single-component system (1K system) is possible.

Such a single-component system has the advantage that it is distinctly easier to use, i.e. is particularly user-friendly, and also saves packaging and production costs. Preferred curable compositions are accordingly in the form of single-component systems.

The catalysts which can be used for crosslinking or polymerizing the compositions according to the invention are the known polyurethanization, allophanatization or biuretization catalysts, which are known per se to those skilled in the art. These include compounds such as the zinc salts, zinc octoate, zinc acetylacetonate and zinc-2-ethylcaproate, or tetraalkylammonium compounds are used, such as N,N,N-trimethyl-N-2-hydroxypropylammonium hydroxide, N,N,N-trimethyl-N-2-hydroxypropylammonium 2-ethylhexanoate or choline 2-ethylhexanoate. Preference is given to the use of zinc octoate (zinc 2-ethylhexanoate) and of the tetraalkylammonium compounds, particular preference to that of zinc octoate. Furthermore, the commonly used organic tin compounds may be used as catalysts, such as dibutyltin dilaurate, dioctyltin dilaurate, dibutyltin diacetylacetonate, dioctyltin diacetylacetonate, dibutyltin diacetate or dibutyltin dioctoate etc. Use may further be made of bismuth catalysts also, e.g. the Borchi catalysts, titanates, e.g. titanium(IV) isopropoxide, iron(III) compounds, e.g. iron(III) acetylacetonate, or else amines, e.g. triethylamine, tributylamine, 1,4-diazabicyclo[2.2.2]octane, 1,8-diazabicyclo[5.4.0]undec-7-ene, 1,5-diazabicyclo[4.3.0]non-5-ene, N,N-bis(N,N-dimethyl-2-aminoethyl)methylamine, N,N-dimethylcyclohexylamine, N,N-dimethylphenylamine, N-ethylmorpholine etc. Also suitable as catalysts are organic or inorganic Brønsted acids, such as acetic acid, trifluoroacetic acid, methanesulphonic acid, toluenesulphonic acid or benzoyl chloride, hydrochloric acid, phosphoric acid monoesters and/or diesters thereof, such as butyl phosphate, (iso)propyl phosphate, dibutyl phosphate, etc. It is of course also possible to employ combinations of two or more catalysts.

The curable compositions according to the invention may also comprise so-called photolatent bases as catalysts, of the kind described in WO 2005/100482. Photolatent bases are to be understood as preferably organic bases having one or more basic nitrogen atoms, which initially are present in a blocked form and which release the basic form only on irradiation with UV light, visible light or IR radiation by splitting of the molecule. The content of the description and the claims of WO 2005/100482 is hereby introduced as part of the present disclosure.

The catalyst or the photolatent base is used in amounts of 0.001 to 5.0% by weight, preferably 0.01 to 1.0% by weight and particularly preferably 0.05 to 0.5% by weight, based on the solids content of the process product. The catalyst or the photolatent base may be added in one portion or alternatively in portions or else continuously. Preferred is the addition of the total amount in one portion.

As further components, the compositions may comprise fillers, solvents, foam stabilizers and also catalysts for accelerating the curing of the foam. Fillers lead to improvement of the breaking strength and also the elongation at break. Common fillers are, for example, calcium carbonate, fumed silica and carbon black. The different fillers are often also used in combination. Suitable as fillers in this case are all materials as are frequently described in the prior art. The fillers are preferably used at a concentration of 0 to 90% by weight, based on the finished mixture, wherein concentrations of 5 to 70% by weight are particularly preferred.

The compositions according to the invention may in addition also comprise other organic substances, preferably liquids and solvents. The solvents used are preferably compounds having a dipole moment.

In addition, known functional substances per se may also be added to the compositions, such as rheological additives, water scavengers, thixotropic agents, flame retardants, defoamers, deaerating agents, film-forming polymers, antimicrobial and preservative substances, antioxidants, dyes, colorants and pigments, antifreeze agents, fungicides, adhesion promoters and/or reactive diluents and also plasticizers and complexing agents, spraying assistants, wetting agents, vitamins, growth substances, hormones, fragrances, light stabilizers, radical scavengers, UV absorbers and also other stabilizers. Preferred curable compositions also preferably have as component e) at least one component selected from water scavengers, plasticizers and/or rheology modifiers.

Innumerable different applications exist for the compositions according to the invention in the field of adhesives, sealants, binders and joint sealants. They are suitable for innumerable different substrates such as mineral substrates, metals, plastics, glass, ceramic, wood, wood-based materials, natural fibers or also cork etc. In principle, the compositions or the foams prepared therefrom are suitable for bonding any articles. They are, however, especially highly suitable when the surfaces to be bonded are uneven or when finely divided fibers or particles, and also cork for example, are to be bonded with one another to a composite material. This is the case, for example, when sealing cracks, where materials no longer superimpose exactly due to splintering or warping, or else for the bonding of skirting boards, coving or other ornamental trims to an uneven wall surface. Here, the foams have the advantage that they are able to provide effective filling even of cavities.

The inventive compositions and the use thereof are described hereinafter by way of example, without any intention that the invention be restricted to these illustrative embodiments. Where ranges, general formulae or compound classes are specified hereinbelow, these shall include not just the corresponding ranges or groups of compounds that are explicitly mentioned but also all sub-ranges and sub-groups of compounds which can be obtained by extracting individual values (ranges) or compounds. Where documents are cited in the context of the present description, it is intended that their content shall form a full part of the disclosure content of the present invention.

Further configurations of the invention arise from the claims, the disclosure content of which is fully incorporated as part of this description.

The examples adduced below illustrate the present invention by way of example, without any intention of restricting the invention, the scope of application of which is apparent from the entirety of the description and the claims, to the embodiments specified in the examples.

### EXPERIMENTAL SECTION

Determination of the Product Composition

The imine content in the reaction product was determined with the aid of ¹³C-NMR spectroscopy. An NMR spectrometer of the Bruker Avance 400 type was used. For this purpose, the samples were dissolved in CDCl₃.

Preparation of the Imine Compounds According to the Method Disclosed in DBP 1104508:

Experiment I1:

1 mol of 3-aminopropyltriethoxysilane (Dynasylan® AMEO (Evonik®))was charged in a 1L three-necked flask equipped with stirrer and distillation apparatus and was heated to 60° C. With vacuum pump switched on and an internal pressure of ca. 30 mbar, 1 mol of cyclohexanone was added dropwise over 1 h. Water of reaction formed was removed continuously by distillation at 60° C. and collected in a distillate container. The reaction and distillation was continued for 3 h after completion of the addition. The resulting ketimine was cooled and dispensed under exclusion of moisture. According to 13C-NMR analysis, 97% of the cyclohexanone used was converted to the ketimine.

Experiment I2:

As described in experiment I1, 1 mol of 3-aminopropyltriethoxysilane (Dynasylan® AMEO (Evonik®)) was reacted with 1 mol of benzaldehyde at 60° C. with continuous removal of water by distillation. The resulting Schiff s base was cooled and dispensed under exclusion of moisture. According to 13C-NMR analysis, 100% of the benzaldehyde used was converted to the imine.

Experiment I3:

As described in experiment I1, 1 mol of 3-aminopropyltriethoxysilane (Dynasylan® AMEO (Evonik®)) was reacted with 1 mol of 2-heptanone at 60° C. with continuous removal of water by distillation. The resulting ketimine was cooled and dispensed under exclusion of moisture. According to 13C-NMR analysis, 100% of the 2-heptanone used was converted to the imine.

Experiment I4:

As described in experiment I1, 1 mol of 3-aminopropyltriethoxysilane (Dynasylan® AMEO (Evonik®)) was reacted with 1.1 mol of butyraldehyde at 100° C. with continuous removal of water by distillation at standard pressure. The resulting ketimine was cooled and dispensed under exclusion of moisture. According to 13C-NMR analysis, ca. 95% of the aminopropyltriethoxysilane used was converted to the imine.

Experiment I5:

As described in experiment I1, 1 mol of 3-aminopropyltriethoxysilane (Dynasylan® AMEO (Evonik®)) was reacted with 1 mol of anisaldehyde at 104° C. with continuous removal of water by distillation. The resulting ketimine was cooled and dispensed under exclusion of moisture. According to 13C-NMR analysis, 100% of the anisaldehyde used was converted to the imine.

Experiment I6:

As described in experiment I1, 1 mol of 3-aminopropyltriethoxysilane (Dynasylan® AMEO (Evonik®)) was reacted with 1 mol of cinnamaldehyde at 104° C. with continuous removal of water by distillation. The resulting ketimine was cooled and dispensed under exclusion of moisture. According to 13C-NMR analysis, 100% of the cinnamaldehyde used was converted to the imine.

Preparation of the Silyl Polyether:

For the storage stability trials, a silyl polyether was used having terminal OH functions and has been prepared by the method described in EP 2 093 244 by alkoxylation of 3-glycidyloxypropyltriethoxysilane (GLYEO) over double metal cyanide catalysts.

Silyl Polyether SP1:

High molecular weight polypropylene glycol-started polyether of average molar mass 16 000 g/mol and fourfold triethoxysilane functionality.

Chemical structure according to monomer metering: Polypropylene glycol (Mw 2000 g/mol)+86 mol of PO+(4 mol of GLYEO/136 mol of PO)

Epoxide oxygen content <0.05%, M_{w} according to GPC 21 400 g/mol, Mn according to GPC 8050 g/mol, viscosity (25.0° C.): 13 100 Pa·s

Urethanized silyl polyether USP 1:

Silyl polyether SP1 was subsequently urethanized according to the method disclosed in DE 10 2009 028636 by reacting the terminal OH functions of the silyl polyether with a 20 mol % excess of isophorone diisocyanate (Vestanat IPDI; Evonik Industries AG) and subsequent reaction of excess NCO groups with a polypropylene glycol monobutyl ether of average molar mass Mw of 400 g/mol. Viscosity of the reaction product (25.0° C.): 32 800 Pa·s, isocyanate content <0.1%.

Silyl-Terminated Polymer USP1

Polymer ST 61 from Evonik Hanse Chemie, viscosity (25.0° C.): 35 000 Pa.s, isocyanate content <0.1%.

Curing Catalyst:

Dioctyltin diacetylacetonate (TIB-Kat 223 from TIB Chemicals) was used for preparing curable mixtures.

Preparation of the Curable Mixtures:

To prepare the curable mixtures, 78 g of each silyl polyether SP1 or USP1 or USP2, 1.6 g of silane adhesion promoter and 0.4 g of dioctyltin diacetylacetonate (TIB-Kat 223 from TIB Chemicals) were weighed out and processed intensively in a speedmixer at room temperature with exclusion of moisture under an argon atmosphere to give a homogeneous and bubble-free mixture. 40 g of each 1K formulation thus prepared were filled into a 50 ml screw-cap sample vial. The samples were then blanketed with dry argon and the sample tubes closed and sealed.

Investigations of the Storage Stability:

For each formulation, a sample was stored at 60° C. in a heating cabinet with exclusion of moisture. The development of the viscosity as an index of the onset of the crosslinking reaction was visually observed in the following time period.

TABLE 1
Storage at 60° C.

| Adhesion | 0 days | | | | | | |
|---|---|---|---|---|---|---|---|
| promoter | (Start) | 2 days | 4 days | 7 days | 14 days | 21 days | 28 days |
| Reference, | Low | High | solid | solid | solid | solid | solid |
| non-inventive | viscosity | viscosity | | | | | |
| SP1 and Dynasylan | | | | | | | |
| AMEO | | | | | | | |
| SP1 and imine I1 | Low | Low | Low | Low | Low | Medium | High |
| | viscosity | viscosity | viscosity | viscosity | viscosity | viscosity | viscosity |
| SP1 and imine I2 | Low | Low | Low | Low | Medium | High | solid |
| | viscosity | viscosity | viscosity | viscosity | viscosity | viscosity | |
| SP1 and imine I3 | Low | Low | Low | Low | Medium | High | solid |
| | viscosity | viscosity | viscosity | viscosity | viscosity | viscosity | |
| SP1 and imine I4 | Low | Low | Low | Medium | solid | solid | solid |
| | viscosity | viscosity | viscosity | viscosity | | | |
| SP1 and imine I5 | Low | Low | Low | Low | Medium | High | solid |
| | viscosity | viscosity | viscosity | viscosity | viscosity | viscosity | |
| SP1 and imine I6 | Low | Low | Low | Low | Medium | High | solid |
| | viscosity | viscosity | viscosity | viscosity | viscosity | viscosity | |

The storage stability tests distinctly show the excellent storage stability of inventive curable mixtures I1 to I6 compared to the reference. As the comparison of the storage stability of I4 with I1, I2, I3, I5, and I6 further shows, it can be clearly seen that the storage stability of inventive curable mixtures is particularly outstanding when the silane compound having imine groups of component a) is a reaction product of a silane compound having amine groups and a carbonyl compound having a boiling point above 80° C. or 100° C.

TABLE 2
Storage at 60° C.

| Adhesion | 0 day | | | | | |
|---|---|---|---|---|---|---|
| promoters | (Start) | 8 days | 16 days | 24 days | 36 days | 90 days |
| Reference, | viscous | viscous | viscous | viscous | highly | Very highly |
| non-inventive | | | | | viscous | viscous |
| USP1 + | | | | | | |
| Dynasylan | | | | | | |
| AMEO | | | | | | |
| USP1 + | viscous | viscous | viscous | viscous | highly | Very highly |
| imine I1 | | | | | viscous | viscous |
| USP1 + | viscous | viscous | viscous | viscous | highly | Very highly |
| imine I2 | | | | | viscous | viscous |
| Reference, | viscous | viscous | viscous | viscous | viscous | viscous |
| non-inventive | | | | | | |
| USP2 + | | | | | | |
| Dynasylan | | | | | | |
| AMEO | | | | | | |
| USP2 + | viscous | viscous | viscous | viscous | viscous | viscous |
| imine I1 | | | | | | |
| USP2 + | viscous | viscous | viscous | viscous | viscous | viscous |
| imine I2 | | | | | | |

As the above table shows, the silane adhesion promoter bearing imine groups may also be employed successfully in curable mixtures with end-capped urethanized silyl polymers such as USP1 and with USP2. The particular advantage which is particularly apparent in such compositions is the odor advantage which is described below.

Odor Tests:

Odor tests, which were carried out before, during and shortly after the curing of the curable mixtures cited above, revealed that all curable mixtures I1 to I6 have a distinctly perceptible smell during the curing, which was experienced as particularly pleasant in I1, I2, I3, I5 and I6. In the reference with Dynasylan AMEO, only the typical vapor of a curable mixture could be perceived but no pleasant smell. The curable mixtures I1, I2, I3, I5 and I6 had moreover, even before the curing, less typical vapors of curable mixtures and emitted a distinctly perceptible, pleasant smell even some time after the start of curing.

1. A curable composition comprising
a. at least one silane compound having imine groups, and
b. at least one prepolymer comprising at least one silyl group.

2. The curable composition according to claim 1, wherein the composition comprises less than 1% by weight of water.

3. The curable composition according to claim 1, wherein the composition further comprises calcium carbonate as component c).

4. The curable composition according to claim 1, wherein the composition further comprises a curing catalyst as component d).

5. The curable composition according to claim 1, wherein the silane compound having imine groups of component a) is a reaction product of a silane compound having amine groups and a carbonyl compound.

6. The curable composition according to claim 1, wherein the composition further comprises no water scavengers, in particular, no vinyltrimethoxysilane and vinyltrimethoxysilane.

7. The curable composition according to claim 1, wherein the silane compound having imine groups of component a) is an aminosilane according to formula (1) 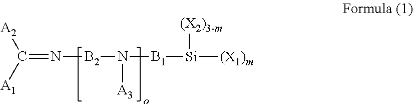
where
X₁ is mutually independently an alkoxy or an aryloxy residue, preferably having 1 to 8 carbon atoms,
X₂ is an alkyl, alkenyl, aryl, alkylaryl or aralkyl residue, preferably an alkyl residue having 1 to 20 carbon atoms,
m is 0, 1, 2 or 3, preferably 2 or 3,
o is 0 or 1,
A₁ and A₂ are mutually independently hydrogen or an organic residue, with the proviso that both residues A₁ and A₂ cannot simultaneously be hydrogen,
B₁ and B₂ are mutually independently divalent hydrocarbon residues having 1 to 18 carbon atoms, and
A₃ is hydrogen or a substituted or unsubstituted residue selected from alkyl, cycloalkyl, alkenyl, aryl, alkylaryl or aralkyl residue, preferably is hydrogen.

8. The curable composition according to claim 1, wherein the compound of component b) takes the form of prepolymers having alkoxysilyl groups of the formula (5) 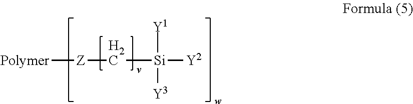
where
Y¹ Y² and Y³ are mutually independently alkyl or alkoxy residues having 1-8 carbon atoms,
Z is a residue comprising a divalent carboxy, carbamate, amide, carbonate, ureido or sulphonate group or is an oxygen atom,
w is an integer from 1 to 8, wherein the respective units with the index w are each mutually independently covalently bonded w-fold to the polymer and
v is an integer from 1 to 20, preferably 1 to 15, and
polymer is a polymer selected from a group consisting of alkyd resins, oil-modified alkyd resins, saturated or unsaturated polyesters, natural oils, epoxides, polyamides, polycarbonates, polyethylenes, polypropylenes, polybutylenes, polystyrenes, polybutadiene, ethylene-propylene copolymers, (meth)acrylates, (meth)acrylamides and salts thereof, phenolic resins, polyoxymethylene homopolymers and copolymers, polyurethanes, polysulphones, polysulphide rubbers, nitrocelluloses, vinyl butyrates, vinyl polymers, ethylcelluloses, cellulose acetates and/or butyrates, rayon, shellac, waxes, ethylene copolymers, organic rubbers, polysiloxanes, polyethersiloxanes, silicone resins, polyethers, polyetheresters, polyether carbonates and mixtures thereof.

9. The curable composition according to claim 1, wherein the prepolymer of component b) takes the form of at least one polyether bearing at least one silyl group.

10. The curable composition according to claim 1, characterized in thatwherein the compound of component b) takes the form of at least one silyl polyether of the formula (6) 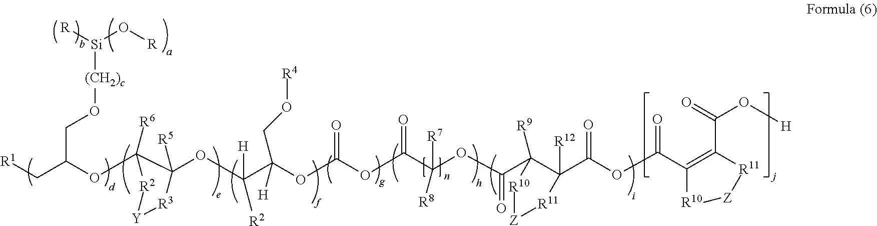
where
a is an integer from 1 to 3, preferably 3,
b is an integer from 0 to 2 and the sum of a and b is equal to 3,
c is an integer from 0 to 22,
d is an integer from 1 to 1000, preferably 1 to 100,
e is an integer from 0 to 10 000, prcfcrably 1 to 2000, particularly prcfcrably 5 to 1000 and in particular is 10 to 500,
f is an integer from 0 to 1000, prcfcrably greater than 0 to 100, particularly prcfcrably 1 to 50 and in particular is 0 to 30,
g is an integer from 0 to 1000, preferably greater than 0 to 200, particularly preferably 1 to 100 and in particular is 0 to 70,
h, i and j are integers from 0 to 500, prcfcrably 0 to 300, particularly prcfcrably 0 to 200 and in particular is 0 to 100,
n is an integer between 2 and 8
and with the proviso that the fragments with the indices d to j are freely permutable with one another, i.e. are exchangeable relative to one another in the sequence within the polyether chain
and
R corresponds to one or more identical or different residues selected from linear or branched, saturated, mono- or polyunsaturated hydrocarbon residues or haloalkyl residues each having 1 to 20;
R¹ corresponds to a saturated or unsaturated, optionally branched residue, which is attached via an oxygen atom, or is a polyether residue of the type of an alkoxy, arylalkoxy or alkylarylalkoxy group, in which the carbon chain can be interrupted by oxygen atoms, or R¹ is an optionally singly or multiply fused aromatic aryloxy group, wherein the residue R¹ in the silyl polyether preferably has no silicon atom, and also
Y may not be present, or may be a methylene bridge with 1 or 2 methylene units and, if Y is present, the residues R² and R³ are each divalent; if Y is not present, the residues R² and R³ are each monovalent,
R² and R³ mutually independently correspond to hydrogen or a saturated or optionally mono- or polyunsaturated, also further substituted, with halogen or hydroxyl groups for example, linear or branched monovalent (if Y not present) or divalent (if Y present) hydrocarbon residue; the hydrocarbon residue may be bridged cycloaliphatically via the fragment Y; if Y is present, neither of the residues R² or R³ can be hydrogen, rather both residues R² and R³ are divalent hydrocarbons;
R⁴ corresponds to a linear or branched alkyl residue of 1 to 24 carbon atoms or an aromatic or cycloaliphatic residue which may in turn bear alkyl groups;
R⁵ and R⁶ mutually independently correspond to hydrogen or a saturated or optionally mono- or polyunsaturated, also further substituted, with halogen or hydroxyl groups for example, linear or branched monovalent hydrocarbon residue,
R⁷ and R⁸ are mutually independently either
hydrogen, alkyl, alkoxy, aryl or aralkyl groups,
R⁹, R¹⁰, R¹¹ and R¹² are mutually independently either
hydrogen, alkyl, alkenyl, alkoxy, aryl or aralkyl groups. The hydrocarbon residue can be bridged cycloaliphatically or aromatically via the fragment Z, where Z may be either a divalent alkylene or alkenylene residue.

11. The curable composition according to claim 9, wherein the polyether of component b) bears at least one OH group on at least one chain end.

12. The use of silane compounds having imine groups as adhesion promoters in curable compositions.

13. The use of curable compositions comprising at least one silane compound having imine groups and at least one prepolymer comprising at least one silyl group as adhesives and sealants, for surface coating and surface modification, as reactive crosslinkers, primers and binders for metals, glass and glass fibers/glass fabrics, wood and silicatic materials.
